(19) United States
(12) Patent Application Publication
(10) Pub. No.: US 2022/0348769 A1
(43) Pub. Date: Nov. 3, 2022

(54) TOILET SEAT ARRANGEMENT

(71) Applicant: Duravit Aktiengesellschaft, Hornberg (DE)

(72) Inventor: Juri WITTICH, Gengenbach (DE)

(21) Appl. No.: 17/707,264

(22) Filed: Mar. 29, 2022

(30) Foreign Application Priority Data
Apr. 29, 2021 (DE) 10 2021 110 977.9

(51) Int. Cl. C08L 101/00; A47K 13/02

(52) U.S. Cl. CPC C08L 101/00; A47K 13/02

(57) ABSTRACT

A toilet seat assembly including a seat or a seat and a lid, where the seat or the seat and the lid are made of a polymer material, wherein the polymer material includes to an extent of 40-99.5 wt % at least one biopolymer, the polymer material including fibers and/or at least one organic or inorganic particulate filler, the fraction of the fibers and/or of the filler being between 0.5-60.0 wt %.

### CROSS-REFERENCE TO RELATED APPLICATIONS

The present application claims priority of DE 10 2021 110 977.9, filed Apr. 29, 2021, the priority of this application is hereby claimed, and this application is incorporated herein by reference.

### BACKGROUND OF THE INVENTION

The invention relates to a toilet seat assembly comprising a seat or a seat and a lid, where the seat or the seat and the lid are made of a polymer material.

A toilet seat assembly of this kind is generally secured by suitable fastening means to a toilet, and has at least one seat, which may have a ring-shaped or U-shaped configuration, and can be pivoted relative to the toilet, meaning that it can be swiveled from a folded-up position into a position lowered onto the toilet, and vice versa. The seat assembly frequently also comprises a lid, which is mounted pivotably in combination with the seat and can be pivoted separately from the seat from a folded-open into a folded-closed position. As well as the production of a seat assembly of this kind, of the seat and the lid, respectively, from wood or a woodbase material, in conjunction with a suitable surface-coating system or coating, seat assemblies of these kinds are commonly made of a polymer material, in other words of plastic. In this case it is usual to employ the plastics families of the thermosets, the thermoplastics, and the polyresins. In the case of the thermosets, the seat, or the seat and the lid, is or are frequently made of a urea resin, e.g., urea-formaldehyde (UF) or of a melamine-formaldehyde resin (MF/MPF). These materials are introduced in pellet form, in appropriate amount, into a compression mold, where they are liquefied at elevated temperature of around 140° C.-160° C. and brought under pressure into the desired shape. After the polymer matrix has cooled, the compression-molded parts can then be demolded. A thermoplastic commonly used is polypropylene (PP), which, in contrast to the thermosets, for example, can be processed to the seat or lid in an injection-molding process.

The polymer materials used are generally based on a petrochemical or fossil starting material, in other words a nonrenewable resource. The production of the respective polymer material from such a starting material is accompanied by release of CO₂, which either enters the environment or requires costly and inconvenient abatement. Moreover, the use of certain polymer materials, such as urea-formaldehyde, for example, is classed as hazardous to health.

### SUMMARY OF THE INVENTION

The problem addressed by the invention, therefore, is that of specifying a toilet seat assembly which is improved in these respects.

To solve this problem, the invention provides a toilet seat assembly comprising a seat or a seat and a lid, where the seat or the seat and the lid are made of a polymer material, which is distinguished by the fact that the polymer material consists to an extent of 40-99.5 wt % of at least one biopolymer, the polymer material comprising fibers and/or at least one organic or inorganic particulate filler, the fraction of the fibers and/or of the filler being between 0.5-60.0 wt %.

A feature of the toilet seat assembly of the invention is that the polymer material used consists to a great extent, or almost completely, of a biopolymer. A biopolymer of this kind is a material which consists of biogenic, i.e., renewable, raw materials, and which, furthermore, may also be biodegradable. The term therefore embraces, in particular, biobased biopolymers, which can be obtained from organic raw materials. Likewise identified as biopolymers, furthermore, are natural polymers, based for example on cellulose or cellulose derivatives, and also biobased plastics which can be produced by chemical modification of the biogenic starting materials, examples being polylactides, these biopolymers being suitable in principle for forming the polymer material or a part of the polymer material from which the seat or the lid is made. The use of such biopolymers therefore makes it possible to forgo the use of polymer materials based on fossil or nonrenewable raw materials to a considerable extent or almost completely. Referring to the seat assembly or to the individual seat or lid, this results in a markedly improved environmental or climatological balance, particularly in light of the fact that no additional greenhouse gases are produced in the course of production and, in particular, usage. It is also possible at least partly or completely to forgo the use of polymer materials which pose a health hazard.

Through use of fibers and/or at least one particulate filler, either organic or inorganic in nature, desired product qualities, more particularly mechanical properties, can be imparted to the seat assembly or to the seat or the lid produced from biopolymer material. The fibers embedded into the polymer matrix serve to reinforce the polymer matrix. Alternatively or additionally, at least one particulate filler may also be introduced or, respectively, embedded into the polymer matrix. A filler of this kind may serve in is particular for adjusting the density of material and also for adjusting the scratch resistance, the impact strength, and also the tensile strength and/or breaking strength.

The overall amount of these adjuvants, whether they be only fibers, only the filler, or fibers and filler, is in the range of 0.5-60 wt %. This means that this fraction, depending on the amount of polymer material, may be relatively low to considerable, according to which properties, more particularly which mechanical properties, the finished seat or lid is to have, and which properties are delivered by the polymer matrix itself, these properties being amenable to further adjustment/enhancement by means of corresponding additions.

As stated, different kinds of biopolymers can be used. It is possible to use a biopolymer of lignin, polylactides, polycaprolactone, natural resins, bio-polyethylene, natural rubber, shellac, gutta percha, cellulose, mastic, starch, proteins, natural fatty acids, or a mixture thereof, and also copolymers of the aforementioned substances. It is therefore possible to use different types of biopolymer, and so there is also a corresponding possibility for selection in relation to the requisite properties of the seat or lid.

In this case only one biopolymer may be used to form the polymer material or a part of the polymer material. Alternatively, however, a mixture of two or more different biopolymers may also form the polymer material or be present therein. This means that it is also possible to use two or more different biopolymers, more particularly of the is polymer types identified above, and this further enlarges the variation spectrum.

As described, according to a first alternative, fibers are embedded into the polymer material or into the cured polymer matrix. These fibers may be, for example, natural fibers, which in conjunction with the biopolymer or biopolymers used reinforces still further the eco-based character. Natural fibers which can be used are, in particular, plant fibers such as bamboo, sisal, flax, coir or corn fibers, which are readily available in sufficient quantity and are sometimes obtained as waste products in the processing of the plants in question. The stated kinds of fiber are, in particular, fast-growing plant materials. In addition it is of course also possible to use wood fibers, in other words likewise natural fibers, which are obtained in large quantity in the processing of wood as well. This means that natural fibers or plant fibers may be used fundamentally.

Additionally or alternatively to this, it is also conceivable for the fibers to be glass fibers, carbon fibers or polymer-based textile fibers. These fibers too are outstandingly suitable as reinforcing fibers and can be embedded without problems into the polymer matrix.

It is conceivable to introduce only one type of fiber—that is, for example, only wood fibers or only glass fibers, or the like. Besides this, however, it is of course also conceivable to embed a mixture of different fibers into the polymer material. This too in turn allows considerable variation in the matrix reinforcement that is achievable in this way.

The length of the fibers used ought to be in the range between 1-10 mm, for a fiber thickness between 0.1-1 mm. If glass fiber is used, preference is given to using fibers 2-5 mm in length.

As fillers too it is possible to use different kinds of filler. It is conceivable for the particulate filler introduced to comprise glass, more particularly spherical glass. This glass, which is incorporated in the form of glass flour, also serves for improving the flow properties in the production context, in other words in the shaping operation.

Alternatively or additionally it is also possible to use a particulate filler in the form of lime, quartz, dolomite, feldspar, silicon carbide, aluminum oxide, aluminum hydroxide, calcium silicate, magnesium silicate, zirconium oxide or titanium oxide. These fillers improve the scratch resistance in particular.

As a particulate filler for improving the flame retardancy it is additionally possible to io introduce aluminum trihydrate or perlite.

A further possibility is to introduce, as a particulate filler, hollow glass spheres or hollow glass beads as well, these being small or ultrasmall hollow bodies which serve in particular to reduce the density and hence the weight of the seat or lid produced.

And, lastly, carbon black as well, for example, in the form of carbon black particles, can be introduced for the purpose of improving the UV resistance or for adjusting the electrical conductivity.

It is of course possible to introduce not only a single type of particulate filler. Instead it is also conceivable to introduce a mixture of two or more different fillers.

The average particle size ought to be in the range between 0.01-2.0 mm, more particularly between 0.05-1 mm.

Frequently it is also desired for the seat or the lid to have a particular color. As well as the possibility of achieving the coloration by means of an applied varnish, it is also conceivable to introduce at least one organic or inorganic pigment at 0.55.0 wt % into the polymer material. This means that a targeted coloring of the material is achieved by way of this pigment, with the article produced accordingly being colored right through.

It is possible, for example, to use inorganic pigments based on oxides, oxyhydroxides, sulfides, silicates, sulfates or carbonates, with examples that may be mentioned including titanium dioxide, via which the customary white color is imparted. A white coloration may also be achieved using aluminum trihydrate, which additionally serves as a flame retardant, zirconium silicate, aluminum oxide, calcium carbonate, barium carbonate, kaolin chamotte, tin oxide or zinc oxide. Iron oxide, silicon carbide, carbon nanotubes or carbon black may be introduced, for example, as pigments for producing darker articles or gray or black articles, and other colors may also be formed by means of corresponding spinels, in which case as well there is a large possibility for color variation.

Alternatively it is also possible to use organic pigments such as, for example, indigo, chlorophyll, and synthetically produced organic colors to achieve coloration.

As well as the possibility of using only one kind of pigment, it is of course conceivable here as well to introduce a mixture of different organic or different inorganic pigments. This means that, ultimately, different color pigments having different colors are mixed, in order to obtain a mixed color and so to extend the color palette further. It is likewise conceivable to introduce a mixture of organic and inorganic pigments.

According to one particularly advantageous development, provision may be made for at least one adjuvant with antibacterial quality to be present at 0.1- 5.0 wt %. By way of io such an adjuvant, the seat assembly or the seat and optionally the lid are given an inherent, quasi-intrinsic antibacterial quality. The reason is that, on the basis of this incorporated antibacterial adjuvant, the seat or lid material inherently has an antibacterial activity to a certain extent, thus being capable of killing bacteria which regularly form colonies on the surface, or at least preventing or limiting their propagation. From a is hygiene standpoint this is a particular advantage, since soiling and hence bacteria may sometimes adhere to a toilet seat assembly. Through incorporation of this adjuvant it is possible, advantageously, to inhibit the propagation of the bacteria or to kill the bacteria.

Such adjuvants present are preferably metal ions, more particularly silver, copper, zinc, lead or tin ions. The inhibition of propagation or the killing is based on an oligodynamic effect. The adjuvant supplying the metal ions is introduced in a simple way in particulate form.

It is conceivable, furthermore, for the seat or the lid to have a coating. Where, for example, no pigments are introduced, coloration would be conceivable via a coating of this kind in the form of a varnish. Preferably, however, the coatings which can be used also have an antibacterial quality, meaning that a surface with antibacterial quality can be applied by way of such coatings—alternatively or additionally to the aforementioned antibacterial adjuvants. A coating of this kind used may be a varnish, a powder coating, a gel coat, a topcoat or a foil. A varnish used may be, for example, a waterborne, solvent borne or oil-based varnish, or ultra-high-solids (UHS) varnishes, which possess a very low solvent fraction and a very low fraction of volatile organic compounds. A gel coat is a coating which is applied as a protective layer and which seals the underlying polymer matrix and at the same time protects it from UV radiation as well. A topcoat also acts similarly. Since both the gel coat and the topcoat are applied in fluid form, it is readily possible to admix such systems, and also the varnish, of course, with corresponding adjuvants, containing, for example, the aforementioned metal ions, pigments or fillers. In the case of powder coating, the abovementioned adjuvants can be added in powder form.

An alternative possibility is the laminating application of a foil, this being a polymeric foil, which is joined firmly to the underlying polymer matrix. This foil as well may be equipped antibacterially by the introduction of corresponding adjuvants in the course of its production.

The invention additionally relates to a sanitary installation comprising a toilet and also a toilet seat assembly of the type described above. This installation may be a floor-mounted toilet or a wall-mounted toilet.

Further advantages and particulars of the present invention arise out of the exemplary embodiment described in the following and also from the associated drawings.

### BRIEF DESCRIPTION OF THE DRAWING

In the drawings:

FIGS. 1-10 show various schematic representations, in section, as partial views of a toilet seat assembly or, respectively, a seat or lid, in each case consisting of different materials.

### DETAILED DESCRIPTION OF THE INVENTION

Indicated below in tables 1 and 2, to start with, are various compositional variants of the material forming the seat or the lid, comprising either just the polymer material or else additional constituents.

TABLE 1

| | wt % | | | |
|---|---|---|---|---|
| | | | | Variant 4 |
| | Variant 1 | Variant 2 | Variant 3 | with filler, fibers, |
| | no filler/ | with | with fillers/ | pigments, |
| Component | adjuvant | pigments | fibers | adjuvant |
| Biopolymer | 60-100 | 55-99 | 40-99 | 40-99 |
| Conventional | 0-40 | 0-40 | 0-40 | 0-40 |
| polymer | | | | |
| Inorganic filler | — | — | 0.5-60 | 0.5-60 |
| Organic filler | — | — | 0.5-60 | 0.5-60 |
| Fibers | | | 0.5-60 | 0.5-60 |
| Pigments | — | 1-5 | 0.5-5 | 0.5-5 |
| Adjuvant with | — | — | — | 0.1-2 |
| antibacterial | | | | |
| effect | | | | |

TABLE 2

| | wt % | | | |
|---|---|---|---|---|
| | | | | Variant 4 |
| | | | | with filler, fibers, |
| | Variant 1 | Variant 2 | Variant 3 | optionally |
| | no filler/ | with | with fillers/ | pigments, |
| Component | adjuvant | pigments | fibers | adjuvant |
| Biopolymer | 60-99 | 55-99 | 40-98 | 40-98 |
| Conventional | 0-49 | 0-39 | 0-40 | 0-40 |
| polymer | | | | |
| Inorganic filler | — | — | 0.5-60 | 0.5-60 |
| Organic filler | — | — | 0.5-60 | 0.5-60 |
| Fibers | | | 0.5-60 | 0.5-60 |
| Pigments | — | 0-5 | 0-5 | 0-5 |
| Adjuvant with | — | — | — | 0-2 |
| antibacterial | | | | |
| effect | | | | |
| Coating | 1-5 | 1-5 | 1-5 | 1-5 |

Table 1 indicates the components forming the seat or lid material. Indicated in addition are four variants 1-4, each having different constituents. The respective amounts are in wt %.

As components forming the material, firstly the biopolymer is indicated, which may be either only one biopolymer, or a mixture of two or more biopolymers.

As a further, optional polymer component, a conventional polymer, i.e., a petroleum-based polymer, is indicated, which, however, need also not be present, if the polymer material is formed exclusively by the biopolymer.

Listed furthermore as an option is an inorganic filler and also an organic filler as components. The fillers are optional as well.

The same is also true of the fibers, which may be introduced for reinforcement.

Also indicated are optional adjuvants in the form of color pigments, and also an optional adjuvant with antibacterial effect.

In the case of variant 1 from table 1, only the polymer material is present, and it may consist either just of 100% biopolymer, or else, additionally, of conventional polymer, in other words of a polymer mixture of biopolymer and conventional polymer. The fraction of conventional polymer here is not more than 40 wt % and the fraction of biopolymer here is not less than 60 wt %. No further components are present.

Variant 2 is distinguished by the fact that, in addition to the biopolymer and the optional conventional polymer, a pigment is present, and the pigment fraction may be 1-5 wt %.

According to variant 3, again, either only biopolymer or additionally conventional polymer as well are present for forming the polymer material, and also present, as already known from variant 2, is a pigment. Additionally indicated are three different filling agents, these being inorganic filler, organic filler, and fibers; in the exemplary embodiment shown, all three are present, but they are correspondingly highly variable in terms of the amount in which they are added. In the example shown, all three are present at not less than 0.5 wt %. This, however, is not absolutely mandatory, but is only the case in the example. It is of course conceivable, for example, also to introduce only inorganic fillers and no organic fillers, and additionally any fibers or the like.

According to variant 4, lastly, which builds on variant 3, there is additionally an adjuvant with antibacterial effect present, specifically at 0.1-2 wt %, in order to endow the seat or lid material overall with an antibacterial quality.

According to table 2, which is constructed like table 1, likewise four different variants of different component compositions are indicated in wt %. These variants 1-4 correspond ultimately to the variants 1-4 from table 1. Here, however, there is additionally indicated a coating as a further component, which covers the base material on the completed seat or lid. The coating, as observed, may be a varnish, a power coating, a topcoat, a gel coat, or a foil applied by lamination. In all variants 1-4 such a coating is provided here, by way of example. Given that this coating as well of course accounts for a certain wt % fraction, there is necessarily a slight variation in the fractions of the other components, since in each variant from tables 1 and 2, of course, the sum total of the respective component fractions is 100 wt %.

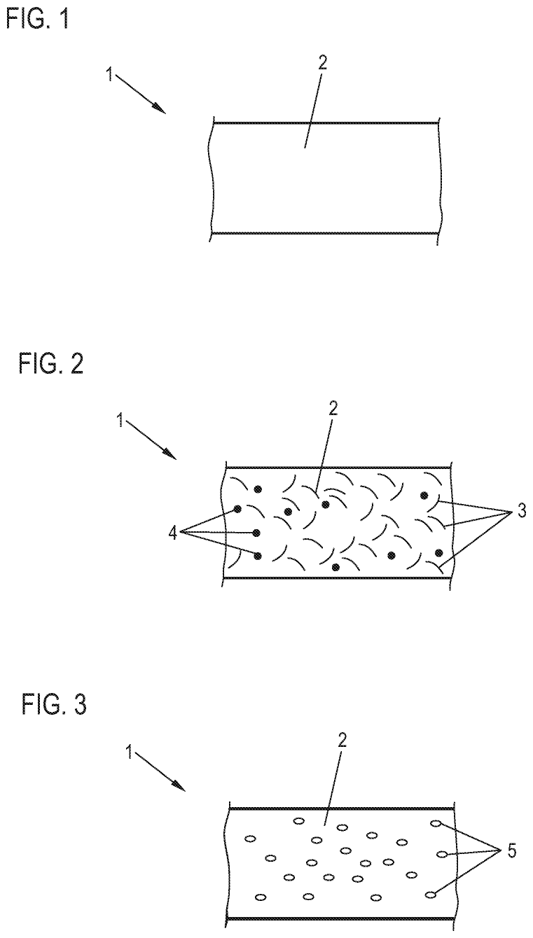

FIGS. 1-10 show different schematic representations as sectional views through a seat or through a lid. Below, fundamentally, the starting point is a seat 1 as the article shown, with the same, of course, being valid for a lid.

According to FIG. 1, the seat 1 consists of a cured polymer material 2, which is either a material consisting of 100% of a biopolymer or of a biopolymer mixture, in which case biopolymers as described in the introduction may be used. Alternatively it is conceivable for the polymer material 2 or the cured polymer matrix also to consist of a mixture of one or more biopolymers and one or more conventional plastics.

In the exemplary embodiment of FIG. 1, the seat 1 consists only of this polymer material 2; there are no further additions present.

In the case of the exemplary embodiment of FIG. 2, fibers 3 are introduced or embedded into the polymer material 2, and serve for reinforcement. The fibers may be wood fibers, bamboo fibers, coir fibers or the like.

In the example shown, there are additionally one or more fillers 4 introduced, which may be the organic or inorganic fillers described, examples being quartz particles, dolomite particles, etc., or else may be hollow glass beads or the like—reference is made to the introductory observations regarding the organic/inorganic fillers which can be used and their function. Although in the example of FIG. 2 there are both fibers 3 and filler 4 present, it is conceivable to introduce only fibers 3 or only fillers 4, in each case of whatever kind. It is of course also conceivable to introduce mixtures of different fibers 3 and/or mixtures of different fillers 4.

In the case of the exemplary embodiment of FIG. 3, the seat 1 consists in turn of the polymer material 2, which in the example shown comprises an adjuvant 5 with an antibacterial effect, thus containing metal ions which exhibit antibacterial effect, such as silver, copper, tin or zinc ions. This adjuvant 5 is introduced in the form of corresponding metal particles or metal-alloy particles.

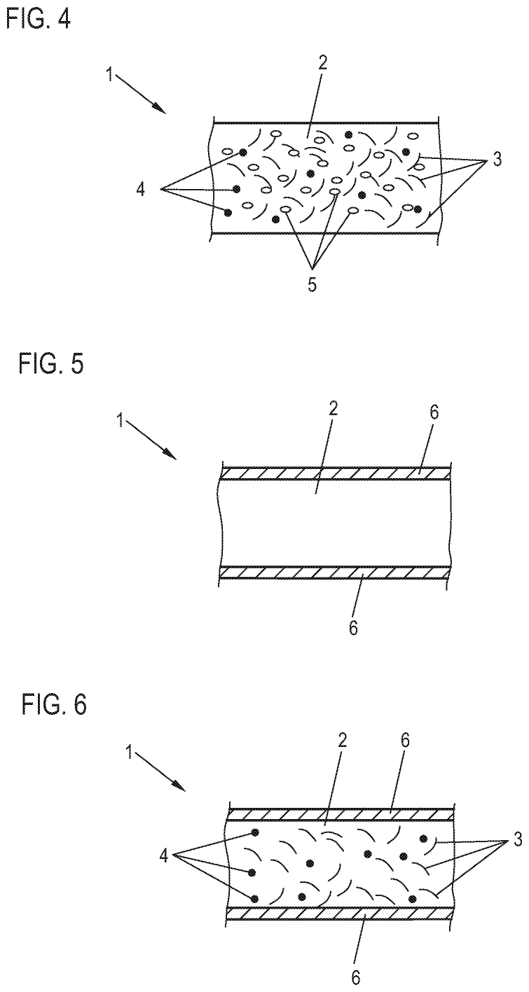

In the case of the exemplary embodiment of FIG. 4, finally, there are both fibers 3 and fillers 4, and also the adjuvant 5 or the metal ions, present in the polymer material 2, which again may consist 100% of biopolymer or of a mixture of biopolymer and conventional polymer.

FIGS. 5-7 show exemplary embodiments of a seat 1, which again consists of a cured polymer material 2, i.e., a polymer matrix. In the case of the example as per 5, only this polymer material 2 is provided, comparably with FIG. 1. In the case of this exemplary embodiment, however, in addition to the polymer material 2, the seat 1 is provided on both sides or faces with a coating 6, as for example a varnish, a powder coating, a gel coat, a topcoat, or a colored or surface-textured foil applied by lamination or adhesive bonding. In the case of the examples of FIGS. 5-7, this coating 6 exclusively defines or influences the appearance, i.e., ultimately, the look and the color or texture or the like. In these exemplary embodiments, the coating 6 lacks other, specific properties.

FIG. 6 shows a variant of a seat 1, again consisting of a polymer material 2, in which here, again, similarly to FIG. 2, fibers 3 are embedded, these fibers, again, being able to be any desired plant fibers or else glass or carbon or textile fibers. Furthermore, in this case there are also fillers 4 of organic and/or inorganic nature present, similarly to the exemplary embodiment of FIG. 2. In contrast to FIG. 2, here, again, a coating 6 is applied on both sides, similarly as described for FIG. 5, but having no specific effect other than io influencing the exterior or the design.

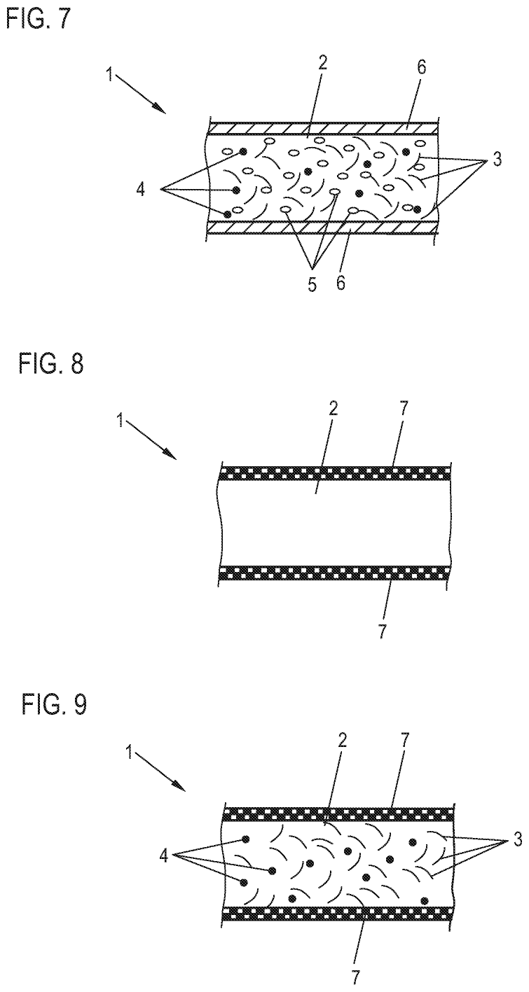

FIG. 7, finally, shows a seat 1 consisting of a polymer material 2 having embedded fibers 3 and also embedded organic and/or inorganic fillers 4. Here in addition, similarly to FIG. 4, there is an adjuvant 5 in the form of metal ions present, in order to give the base material an antibacterial quality.

In line with the examples of FIGS. 5 and 6, here again, on top and bottom sides, there is a coating 6 in each case, applied in the form of a varnish, gel, topcoat or foil.

FIGS. 8-10, lastly, show a third variation of a seat 1, which again consists of a polymer material 2, which may consist 100% of biopolymer or of a mixture of biopolymer and conventional polymer. Here as well there is a coating applied on the top and bottom sides, but this coating 7—in contrast to the coating 6—additionally has an antibacterial effect. This means that in the varnish or gel coat or topcoat or foil that is used, there is a corresponding adjuvant with antibacterial effect incorporated, this being a particulate substance which contains corresponding metal ions, distributed respectively in the corresponding matrix. By means of this adjuvant, then, the surface in each case is furnished antibacterially.

In the case of the exemplary embodiment of FIG. 9, the polymer material 2 again contains the embedded fibers 3 and also the embedded fillers 4, either organic or inorganic fillers. In addition, here again, there is also a coating 7, having antibacterial properties, applied on both sides to the base material.

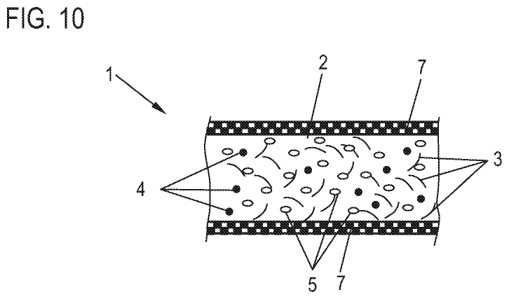

The exemplary embodiment of FIG. 10, lastly, shows a seat 1 made of a polymer material 2, in which not only fibers 3 but also fillers 4 and also the adjuvant 5, which imparts the antibacterial quality, or provides the metal ions, are embedded, in accordance with the exemplary embodiments of FIGS. 4 and 7. In line with the exemplary embodiments of FIGS. 8 and 9, the polymer material 2 here as well is provided on top and bottom sides with a coating 8 having antibacterial quality. The advantage of the embedding of the adjuvant 8 with the antibacterial quality into the polymer material 2 itself, meaning that the base material in total has antibacterial qualities, is that, should the likewise antibacterial coating 8 become damaged at any point, the surface still has antibacterial qualities, which in that case are, however, provided locally in the region of the damage by the base material or the adjuvant 5 there.

According to the components used, and/or to the nature of the starting materials, different production processes are conceivable. It is possible, for instance, to produce the seat or lid using particulate starting materials, hence in the form of corresponding pellets or the like, in a compression molding process with metal molds made, for example, of stainless steel, nickel or aluminum, in which case the particulate components are first melted by heating and then shaped.

As an alternative to this, it is also conceivable to produce the seat or lid using corresponding particulate components in an injection-molding process, in which case, of course, the polymer material or its starting components are first melted, to form an injectable composition comprising the other particulate components in bound form.

A further possibility is to produce the seat or the lid from a prefabricated semifinished product, such as a sheet or a plate, by thermoforming. This prefabricated semifinished product consists of all the necessary components forming the base material. The thermoforming process merely gives this semifinished product the appropriate final shape.

It is conceivable, furthermore, to produce the seat or lid from a suitable molding compound, produced on the basis of the particulate components, in a sheet molding compound (SMC) process using compression molds.

After the corresponding molding has been produced, it may either be already complete, or else an additional coating may be applied, which either has visual qualities only, or may additionally have been furnished antibacterially as well.

While specific embodiments of the invention have been shown and described in detail to illustrate the inventive principles, it will be understood that the invention may be embodied otherwise without departing from such principles.

1. A toilet seat assembly comprising a seat or a seat and a lid, where the seat or the seat and the lid are made of a polymer material, wherein the polymer material consists to an extent of 40- 99.5 wt % of at least one biopolymer, the polymer material comprising fibers and/or at least one organic or inorganic particulate filler, the fraction of the fibers and/or of the filler being between 0.5-60.0 wt %.

2. The toilet seat assembly according to claim 1, wherein the biopolymer is a biopolymer of lignin, polylactides, polycaprolactone, natural resins, bio-polyethylene, natural rubber, shellac, gutta percha, cellulose, mastic, starch, proteins, natural fatty acids, or a mixture thereof, or a copolymer of the aforementioned substances.

3. The toilet seat assembly according to claim 1, wherein a mixture of two or more different biopolymers is present.

4. The toilet seat assembly according to claim 1, wherein the fibers are fibers of a natural substance.

5. The toilet seat assembly according to claim 4, wherein the fibers are wood, bamboo, sisal, flax, coir or corn fibers.

6. The toilet seat assembly according to claim 1, wherein the fibers are glass, carbon, or polymer-based textile fibers.

7. The toilet seat assembly according to claim 1, wherein a mixture of different fibers is present.

8. The toilet seat assembly according to claim 1, wherein filler present comprises glass, more particularly spherical glass, lime, quartz, dolomite, feldspar, silicon carbide, aluminum oxide, aluminum hydroxide, calcium silicate, magnesium silicate, zirconium oxide, titanium oxide, aluminum trihydrate, perlite, hollow glass spheres or hollow glass beads, or carbon black.

9. The toilet seat assembly according to claim 1, wherein a mixture of different fillers is present.

10. The toilet seat assembly according to claim 1, wherein at least one organic or inorganic pigment is present at 0.5-5.0 wt %.

11. The toilet seat assembly according to claim 10, wherein the organic pigment is indigo, chlorophyll, and synthetically produced organic colors, or the inorganic pigment is a pigment based on oxides, oxyhydroxides, sulfides, silicates, sulfates or carbonates.

12. The toilet seat assembly according to claim 10, wherein a mixture of different organic or inorganic pigments or a mixture of organic and inorganic pigments is present.

13. The toilet seat assembly according to claim 1, wherein at least one adjuvant with antibacterial quality is present at 0.1-5.0 wt %.

14. The toilet seat assembly according to claim 13, wherein the adjuvant comprises metal ions, more particularly silver, copper, tin or zinc ions.

15. The toilet seat assembly according to claim 1, wherein the seat or the lid has a coating.

16. The toilet seat assembly according to claim 15, wherein the coating is a varnish, powder coating, gel coat, topcoat or foil.

17. The toilet seat assembly according to claim 15, wherein the coating has antibacterial qualities.

18. A sanitary installation comprising a toilet and a toilet seat assembly according to claim 1.
